(19) United States
(12) Patent Application Publication
(10) Pub. No.: US 2010/0196592 A1
(43) Pub. Date: Aug. 5, 2010

(54) METHODS OF FABRICATING CAPACITORS INCLUDING LOW-TEMPERATURE CAPPING LAYERS

(75) Inventors: Wan-Don Kim, Yongin-si (KR); Kyu-Ho Cho, Hwaseong-si (KR); Jin-Yong Kim, Guri-si (KR); Jae-Hyoung Choi, Hwaseong-si (KR); Jae-Soon Lim, Seoul (KR); Oh-Seong Kwon, Hwaseong-si (KR); Beom-Seok Kim, Suwon-si (KR); Yong-Suk Tak, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/699,576

(22) Filed: Feb. 3, 2010

(30) Foreign Application Priority Data
Feb. 4, 2009 (KR) 10-2009-0008812

(51) Int. Cl. B05D 5/12

(52) U.S. Cl. 427/79

(57) ABSTRACT

In a method of fabricating a capacitor, a lower electrode is formed, and a dielectric layer is formed on the lower electrode. An upper electrode is foamed on the dielectric layer opposite the lower electrode. A low-temperature capping layer is formed on the upper electrode at a temperature of less than about 300° C. Related devices and fabrication methods are also discussed.

### CLAIM OF PRIORITY

This application claims priority under 35 USC §119 from Korean Patent Application No. 10-2009-0008812, filed on Feb. 4, 2009 in the Korean Intellectual Property Office (KIPO), the disclosure of which is hereby incorporated by reference in its entirety.

### FIELD

Example embodiments relate to capacitors and methods of forming the same.

### BACKGROUND

As semiconductor devices have become more highly integrated, forming capacitors having relatively high capacitance has become more difficult. Thus, methods of forming capacitors having a higher capacitance have been studied. For example, capacitors having a dielectric layer including a high-k material and an electrode including a metal have been developed. However, when an electrode is formed using a metal, the capacitors may have poor leakage current characteristics because the metal electrode may be affected by heat during the formation of the capacitors.

### SUMMARY

Example embodiments provide capacitors having relatively high capacitance and low leakage current characteristics.

Example embodiments provide methods of fabricating capacitors having relatively high capacitance and low leakage current characteristics.

According to example embodiments, a capacitor includes a lower electrode, a dielectric layer on the lower electrode, a upper electrode on the dielectric layer opposite the lower electrode, and a low-temperature capping layer on the upper electrode. The low-temperature capping layer comprises an oxide configured to substantially inhibit grain growth in the upper electrode.

In example embodiments, the upper electrode may include a material having a higher work function than the dielectric layer.

In example embodiments, the dielectric layer may include a metal oxide having a higher dielectric constant than silicon dioxide (SiO₂).

In example embodiments, the dielectric layer may include at least one of a binary metal oxide and a ternary perovskite material, and the upper electrode may include at least one of a noble metal, a conductive noble metal oxide, and a conductive perovskite oxide.

In example embodiments, the low-temperature capping layer may be under tensile stress. The low-temperature capping layer may have a thickness of about 5 Angstroms (Å) to about 3000 Å.

According to further example embodiments, a method of fabricating a capacitor includes forming a lower electrode. A dielectric layer is formed on the lower electrode. A upper electrode is formed on the dielectric layer opposite the lower electrode. A low-temperature capping layer is formed on the upper electrode at a temperature that is insufficient to induce grain growth in the upper electrode.

In example embodiments, the low-temperature capping layer may be an oxide layer formed at a temperature of about 10 to about 300° C.

In example embodiments, the low-temperature capping layer may be configured to substantially inhibit grain growth in the upper electrode during subsequent thermal processes.

In example embodiments, the upper electrode may include a material having a higher work function than the dielectric layer.

In example embodiments, the dielectric layer may include a metal oxide having a higher dielectric constant than silicon dioxide (SiO₂).

In example embodiments, the dielectric layer may be formed using a perovskite material.

In example embodiments, the dielectric layer may be formed using (Ba, Sr)TiO₃(BST), strontium titanate (SrTiO₃), barium titanate (BaTiO₃), PZT, PLZT, (Ba, Sr)(Zr, Ti)O₃(BSZTO), Sr(Zr, Ti)O₃(SZTO), Ba(Zr, Ti)O₃(BZTO), (Ba, Sr)ZrO₃(BSZO), strontium zirconate (SrZrO₃) or barium zirconate (BaZrO₃). These may be used alone or in combination.

In example embodiments, the dielectric layer may be formed using zirconium oxide (ZrO₂), hafnium dioxide (HfO₂), aluminum oxide (Al₂O₃), tantalum oxide (Ta₂O₅) or titanium oxide (TiO₂). These may be used alone or in combination.

In example embodiments, the upper electrode may be formed using a noble metal.

In example embodiments, the upper electrode may be formed using platinum (Pt), ruthenium (Ru) and/or iridium (Ir).

In example embodiments, the upper electrode may be formed using a conductive noble metal oxide and/or a conductive perovskite oxide.

In example embodiments, the upper electrode may be formed using platinum monoxide (PtO), ruthenium dioxide (RuO₂), iridium dioxide (IrO₂), strontium ruthenate (SrRuO₃), barium ruthenate (BaRuO₃), calcium ruthenate (CaRuO₃) or (Ba, Sr)RuO₃.

In example embodiments, an atomic layer deposition (ALD) process or a spin coating process may be used to form the capping layer.

In example embodiments, the capping layer may be formed using zirconium oxide (ZrO₂), hafnium dioxide (HfO₂), aluminum oxide (Al₂O₃), lanthanum monoaluminate (LaAlO₃), barium zirconate (BaZrO₃), strontium zirconate (SrZrO₃), BST, strontium titanate (SrTiO₃), barium titanate (BaTiO₃), titanium dioxide (TiO₂) and silicon oxide (SiO₂). These may be used alone or in combination.

In example embodiments, the capping layer may be an oxide layer having tensile stress. The low-temperature capping layer may have a thickness of about 5 Angstroms (Å) to about 3000 Å.

In example embodiments, a plurality of lower electrodes may be formed on the substrate, and the capping layer may be formed on the upper electrode to fill a space between the lower electrodes.

According to some example embodiments, the capacitor may include a dielectric layer including a high-k material and the capping layer may substantially inhibit grain growth in the upper electrode. Thus, the capacitor may have a reduced leakage current.

### BRIEF DESCRIPTION OF THE DRAWINGS

Example embodiments will be more clearly understood from the following detailed description taken in conjunction with the accompanying drawings. FIGS. 1 to 20 represent non-limiting, example embodiments as described herein.

FIG. 1 is a cross-sectional view illustrating a first capacitor in accordance with example embodiments;

FIGS. 2 to 8 are cross-sectional views illustrating a method of forming the first capacitor in accordance with example embodiments;

FIG. 9 is a cross-sectional view illustrating a first semiconductor device having the first capacitor in FIG. 1 in accordance with example embodiments;

FIG. 10 is a cross-sectional view illustrating a second semiconductor device having the first capacitor in FIG. 1 in accordance with example embodiments;

FIG. 11 is a cross-sectional view illustrating a second capacitor according to example embodiments;

FIGS. 12 to 14 are cross-sectional views illustrating a method of forming the second capacitor in accordance with example embodiments;

FIG. 15 is a cross-sectional view illustrating a third capacitor according to example embodiments;

FIGS. 16 to 18 are cross-sectional views illustrating a method of forming the third capacitor in accordance with example embodiments;

FIG. 19 is a graph illustrating leakage current characteristics of a capacitor when the capacitor is heated; and

FIG. 20 is a graph illustrating leakage current characteristics of a capacitor according to example embodiments when the capacitor has a capping layer.

### DETAILED DESCRIPTION OF THE EMBODIMENTS

The present inventive concept will now be described more fully hereinafter with reference to the accompanying drawings, in which some example embodiments are shown. This inventive concept, however, may be embodied in many different fauns and should not be construed as limited to the embodiments set forth herein. Rather, these embodiments are provided so that this disclosure will be thorough and complete, and will fully convey the scope of the inventive concept to those skilled in the art. In the drawings, the thicknesses of layers and regions may be exaggerated for clarity. Like numbers refer to like elements throughout.

It will be understood that when an element or layer is referred to as being “on”, “connected to” or “coupled to” another element or layer, it can be directly on, connected or coupled to the other element, or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath”, “below”, “bottom”, “lower”, “above”, “top”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly. Also, as used herein, “lateral” refers to a direction that is substantially orthogonal to a vertical direction.

The terminology used herein is for the purpose of describing particular embodiments only, and is not intended to be limiting of the present inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the present inventive concept are described herein with reference to cross-section illustrations that are schematic illustrations of idealized embodiments (and intermediate structures) of the inventive concept. As such, variations from the shapes of the illustrations as a result, for example, of manufacturing techniques and/or tolerances, are to be expected. Thus, embodiments of the present inventive concept should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. Accordingly, these terms can include equivalent terms that are created after such time. It will be further understood that terms, such as those defined in commonly used dictionaries, should be interpreted as having a meaning that is consistent with their meaning in the present specification and in the context of the relevant art, and will not be interpreted in an idealized or overly formal sense unless expressly so defined herein.

Hereinafter, example embodiments will be explained in detail with reference to the accompanying drawings.

FIG. 1 is a cross-sectional view illustrating a first capacitor in accordance with example embodiments.

Referring to FIG. 1, an insulating interlayer 102 may be formed on a substrate 100. The substrate 100 may include a semiconductor material such as silicon, germanium, silicon-germanium, and the like. A contact plug 104 may be formed through the insulating interlayer 102 and make contact with the substrate 100. Other devices such as transistors (not shown) and wirings (not shown) may be further formed on the substrate 100.

A lower electrode 112 may be formed on the insulating interlayer 102. In example embodiments, the lower electrode 112 may have a pillar shape. The lower electrode 112 may contact a top surface of the contact plug 104.

The lower electrode 112 may include a metal such as a noble metal, a conductive noble metal oxide, a conductive perovskite oxide, and the like. For example, the lower electrode 112 may include platinum (Pt), ruthenium (Ru), iridium (Ir), platinum monoxide (PtO), ruthenium dioxide (RuO₂), iridium dioxide (IrO₂), strontium ruthenate (SrRuO₃), barium ruthenate (BaRuO₃), calcium ruthenate (CaRuO₃), (Ba, Sr)RuO₃, etc. These may be used alone or in combination thereof.

Alternatively, the lower electrode 112 may include a refractory metal or a refractory metal nitride. For example, the lower electrode 112 may include titanium (Ti), titanium mononitride (TiN), tungsten (W), tungsten nitride (WN), tantalum (Ta), tantalum nitride (TaN), hafnium mononitride (HfN), zirconium mononitride (ZrN), titanium aluminum nitride (TiAlN), tantalum silicon nitride (TaSiN), tantalum aluminum nitride (TaAlN), etc.

These may be used alone or in combination thereof.

An etch stop layer 106 may be formed on the insulating interlayer 102. The etch stop layer 106 may surround a lower portion of the lower electrode 112. The etch stop layer 106 may include silicon nitride.

A dielectric layer 114 may be formed on the lower electrode 112 and the etch stop layer 114. The dielectric layer 114 may include a metal oxide having a relatively high dielectric constant, e.g., higher than that of an oxide-nitride-oxide (ONO) layer.

The dielectric layer 114 may include a perovskite trinary or ternary material. For example, the dielectric layer 114 may include (Ba, Sr)TiO₃ (BST), strontium titanate (SrTiO₃), barium titanate (BaTiO₃), PZT, PLZT, (Ba, Sr)(Zr, Ti)O₃ (BSZTO), Sr(Zr, Ti)O₃ (SZTO), Ba(Zr, Ti)O₃ (BZTO), (Ba, Sr)ZrO₃ (BSZO), strontium zirconate (SrZrO₃), barium zirconate (BaZrO₃), etc. Alternatively, the dielectric layer 114 may include a binary material. For example, the dielectric layer 114 may include zirconium oxide (ZrO₂), hafnium dioxide (HfO₂), aluminum oxide (Al₂O₃), tantalum oxide (Ta₂O₅), titanium oxide (TiO₂), etc.

An upper electrode 116 may be formed on the dielectric layer 114. The upper electrode 116 may include a noble metal having a relatively high work function. Alternatively, the upper electrode 116 may include a conductive noble metal oxide or a conductive perovskite oxide. The upper electrode 116 may have such a high work function that the work function difference between the upper electrode 116 and the dielectric layer 114 may be relatively large. Thus, the first capacitor may have a reduced leakage current.

For example, the upper electrode 116 may include platinum (Pt), ruthenium (Ru), iridium (Ir), platinum monoxide (PtO), ruthenium dioxide (RuO₂), iridium dioxide (IrO₂), strontium ruthenate (SrRuO₃), barium ruthenate (BaRuO₃), calcium ruthenate (CaRuO₃), (Ba, Sr)RuO₃, etc. These may be used alone or in combination thereof.

A low temperature capping layer 118 may be formed on the upper electrode 116. The capping layer 118 may be configured to affect gain boundary properties of the upper electrode, and in particular, may reduce or prevent growth and/or conglomeration of grains in the upper electrode 116 when heated.

When a heat treatment is performed on the upper electrode 116 having the noble metal at a temperature of more than about 350° C., grains of the upper electrode 116 may grow and conglomerate with each other. Thus, the dielectric layer 114 may be damaged by the grown and conglomerated grains, which may result in leakage current.

If a surface of the upper electrode 116 is exposed, the growth and/or conglomeration of the grains may occur more actively. Thus, the capping layer 118 substantially and/or completely covering the upper electrode 116 may reduce, prevent, and/or substantially inhibit grain growth and/or conglomeration during subsequent thermal processes.

The low-temperature capping layer 118 may include a material deposited at a low temperature of about 10° C. to about 300° C., so that the grains of the upper electrode 116 may not grow during the formation of the capping layer. In other words, the deposition temperature of the capping layer 118 may be insufficient to induce grain growth in the upper electrode 116. The capping layer 118 may include a material having good step coverage characteristics and not being transformed by stress. The capping layer 118 may include an oxide.

For example, the capping layer 118 may include zirconium oxide (ZrO₂), hafnium dioxide (HfO₂), aluminum oxide (Al₂O₃), lanthanum monoaluminate (LaAlO₃), barium zirconate (BaZrO₃), strontium zirconate (SrZrO₃), barium strontium titanate (BST), strontium titanate (SrTiO₃), barium titanate (BaTiO₃), titanium dioxide (TiO₂), silicon oxide (SiO₂), etc. These may be used alone or in combination thereof. The capping layer 118 may include zirconium oxide (ZrO₂) or hafnium dioxide (HfO₂) having a tensile stress on the silicon substrate 100.

In example embodiments, the capping layer 118 may have a thickness of about 5 Angstroms (Å) to about 3000 Å.

When a plurality of first capacitors are foamed, the capping layer 118 may fill spaces between a plurality of lower electrodes 112. Alternatively, the capping layer 118 may be a thin film covering the upper electrode 116.

The first capacitor may include the dielectric layer 114 having a high dielectric constant and the upper electrode 116 having a high work function. Additionally, the grains of the upper electrode 116 may not be very large (e.g. may be relatively small) because growth of the grains may be reduced and/or prevented by the capping layer 118. Thus, the first capacitor may have relatively high capacitance and low leakage current characteristics.

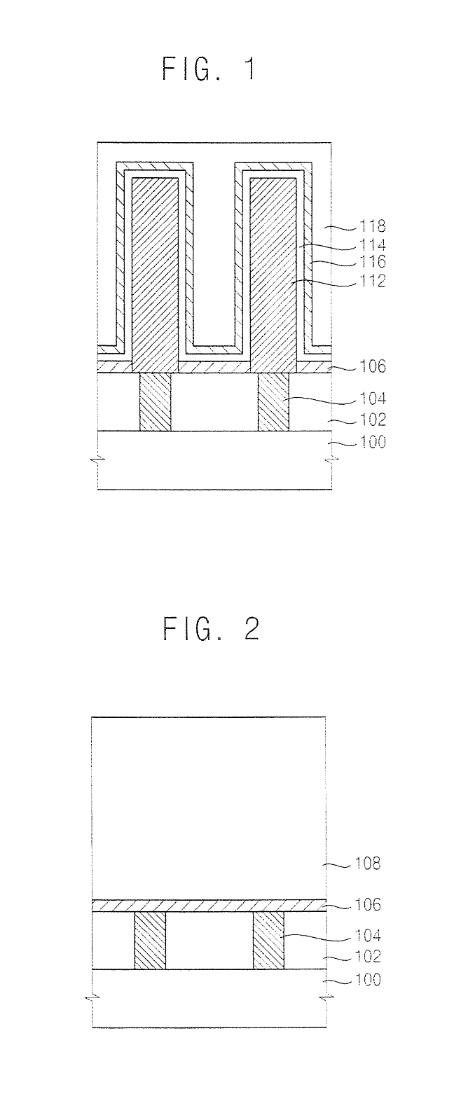

FIGS. 2 to 8 are cross-sectional views illustrating a method of forming the first capacitor in accordance with example embodiments.

Referring to FIG. 2, an insulating interlayer 102 is formed on a substrate 100. The substrate 100 may include a semiconductor material such as silicon, germanium, silicon-germanium, and the like. The insulating interlayer 102 may be formed using an oxide such as silicon oxide. The insulating interlayer 102 may be partially removed to form a hole exposing a top surface of the substrate 100. In example embodiments, a plurality of holes may be formed through the insulating interlayer 102. Prior to forming the insulating interlayer 102, other devices such as transistors, wirings, etc. may be further formed.

A contact plug 104 may be formed on the substrate 100 to fill the hole. The contact plug 104 may be formed using a conductive material.

An etch stop layer 106 may be formed on the insulating interlayer 102 and the contact plug 104. The etch stop layer 106 may be formed by a chemical vapor deposition (CVD) process using silicon nitride.

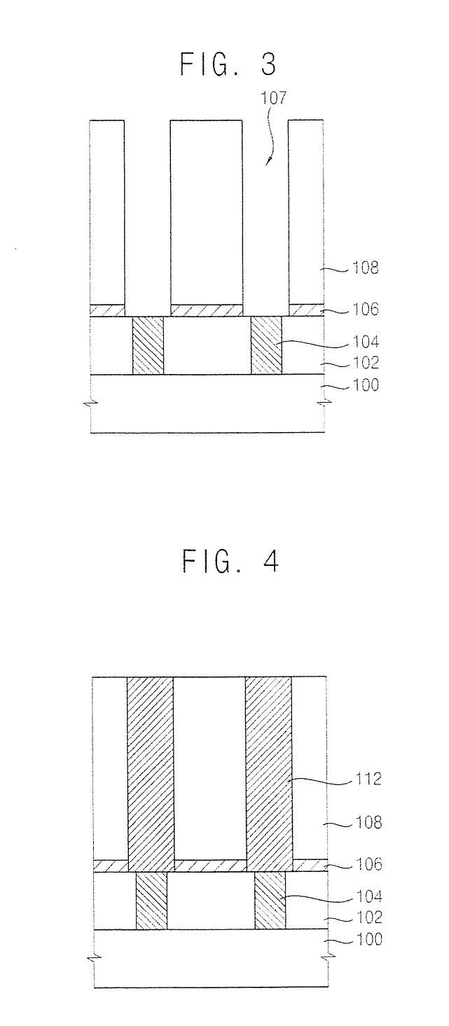

A mold layer 108 may be fail led on the etch stop layer 106. The mold layer 108 may be formed to have a height equal to or higher than that of a lower electrode (see FIG. 4). The mold layer 108 may be formed using a material having an etching selectivity with respect to the etch stop layer 106. The mold layer 108 may be formed using an oxide. For example, the mold layer 108 may be formed using boro-phosphosilicate glass (BPSG), tonen silazene (TOSZ), high density plasma (HDP) oxide, plasma enhanced tetraethyl orthosilicate (PE-TEOS), etc.

Referring to FIG. 3, the mold layer 108 and the etch stop layer 106 therebeneath may be partially removed to form an opening 107 exposing a top surface of the contact plug 104.

Referring to FIG. 4, a first conductive layer is formed on the contact plug 104 and the mold layer 108 to fill the opening 107 to provide a lower electrode 112. The first conductive layer may be formed using a metal such as a noble metal, a conductive noble metal oxide, a conductive perovskite oxide, and the like. For example, the first conductive layer may include platinum (Pt), ruthenium (Ru), iridium (Ir), platinum monoxide (PtO), ruthenium dioxide (RuO₂), iridium dioxide (IrO₂), strontium ruthenate (SrRuO₃), barium ruthenate (BaRuO₃), calcium ruthenate (CaRuO₃), (Ba, Sr)RuO₃, etc. These may be used alone or in combination thereof.

Alternatively, the first conductive layer may be formed using a refractory metal or a refractory metal nitride. For example, the lower electrode 112 may include titanium (Ti), titanium mononitride (TiN), tungsten (W), tungsten nitride (WN), tantalum (Ta), tantalum nitride (TaN), hafnium mononitride (MN), zirconium mononitride (ZrN), titanium aluminum nitride (TiAlN), tantalum silicon nitride (TaSiN), tantalum aluminum nitride (TaAlN), etc. These may be used alone or in combination thereof.

The first conductive layer may be formed by an atomic layer deposition (ALD) process, a chemical vapor deposition (CVD) process or a physical vapor deposition (PVD) process. For example, the first conductive layer may be formed by an ALD process having good step coverage characteristics.

An upper portion of the first conductive layer may be planarized until a top surface of the mold layer 108 is exposed, thereby forming a lower electrode 112. The lower electrode 112 may have a pillar shape.

A heat treatment process may be further performed on the lower electrode 112. If the heat treatment process is performed, grains of the lower electrode 112 may grow before a dielectric layer 114 (see FIG. 6) is formed on the lower electrode 112. Thus, the characteristics of the dielectric layer 114 may not be changed due to the growth of the grains of the lower electrode 112 prior to formation of the dielectric layer 114.

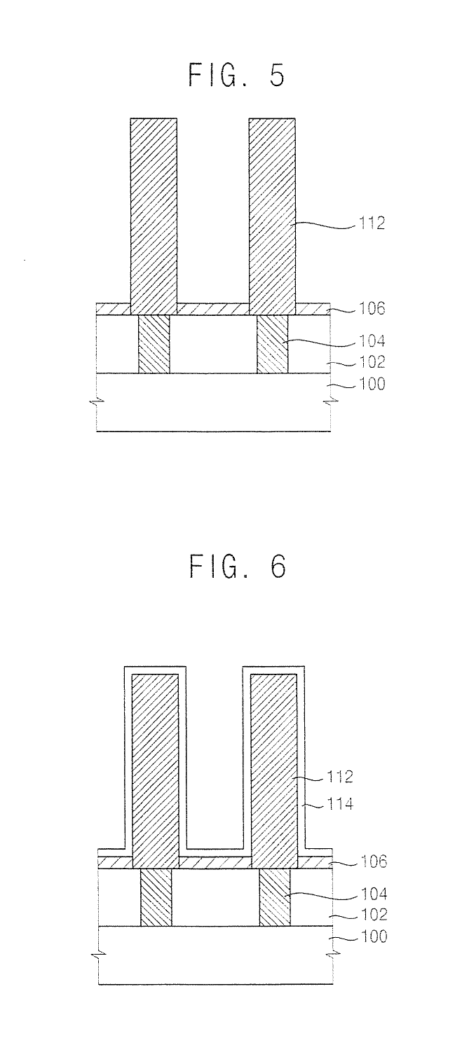

Referring to FIG. 5, the mold layer 108 may be removed from the substrate 100, and thus a top surface of the lower electrode 112 may be exposed. In example embodiment, the mold layer 108 may be removed by a wet etching process in which the top surface of the lower electrode 112 may not be damaged.

Referring to FIG. 6, the dielectric layer 114 may be formed on the lower electrode 112 and the etch stop layer 106. The dielectric layer 114 may be formed using a metal oxide having a relatively high dielectric constant, e.g., higher than that of an oxide-nitride-oxide (ONO) layer.

In example embodiments, the dielectric layer 114 may be formed using a perovskite trinary material. For example, the dielectric layer 114 may be formed using (Ba, Sr)TiO₃ (BST), strontium titanate (SrTiO₃), barium titanate (BaTiO₃), PZT, PLZT, (Ba, Sr)(Zr, Ti)O₃ (BSZTO), Sr(Zr, Ti)O₃ (SZTO), Ba(Zr, Ti)O₃ (BZTO), (Ba, Sr)ZrO₃ (BSZO), strontium zirconate (SrZrO₃), barium zirconate (BaZrO₃). etc. Alternatively, the dielectric layer 114 may be formed using a binary material. For example, the dielectric layer 114 may be formed using zirconium oxide (ZrO₂), hafnium dioxide (HfO₂), aluminum oxide (Al₂O₃), tantalum oxide (Ta₂O₅), titanium oxide (TiO₂), etc.

The dielectric layer 114 may be formed by an ALD process, a CVD process or a PVD process. For example, the dielectric layer 114 may be formed by an ALD process having good step coverage characteristics.

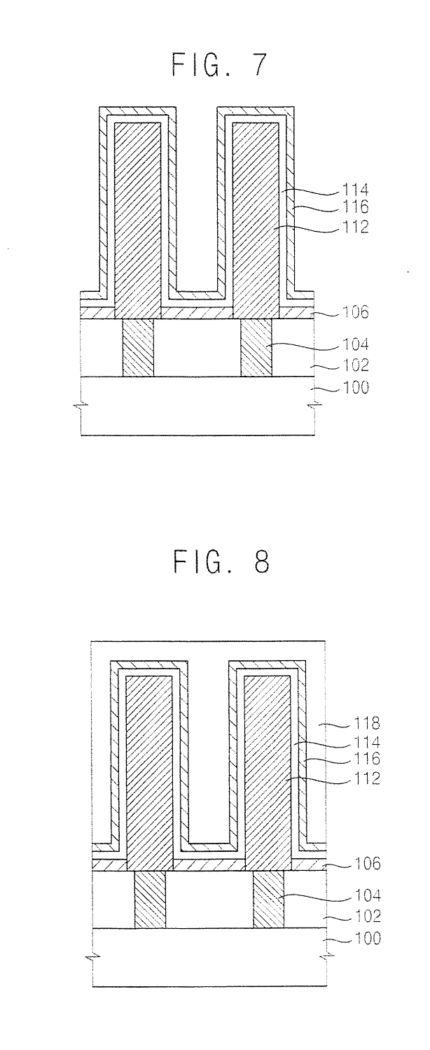

Referring to FIG. 7, an upper electrode 116 may be foamed on the dielectric layer 114. The upper electrode 116 may be formed using a noble metal having a relatively high work function. Alternatively, the upper electrode 116 may be formed using a conductive noble metal oxide or a conductive perovskite oxide.

For example, the upper electrode 116 may be formed using platinum (Pt), ruthenium (Ru), iridium (Ir), platinum monoxide (PtO), ruthenium dioxide (RuO₂), iridium dioxide (IrO₂), strontium ruthenate (SrRuO₃), barium ruthenate (BaRuO₃), calcium ruthenate (CaRuO₃), (Ba, Sr)RuO₃, etc. These may be used alone or in combination thereof.

In example embodiments, the upper electrode 116 may be formed to have a thickness of less than about 2000 Å.

The upper electrode 116 may be formed by an ALD process, a CVD process or a PVD process. For example, the upper electrode 116 may be formed by an ALD process having good step coverage characteristics.

If the upper electrode 116 is formed using polysilicon on the dielectric layer 114 including the metal oxide having a high dielectric constant, the polysilicon of the upper electrode 116 and the metal oxide of the dielectric layer 114 may react with each other, thereby forming a layer having a relatively low dielectric constant. Thus, the first capacitor may have a low capacitance and poor leakage current characteristics.

However, when the dielectric layer 114 is formed using the material having a relatively high dielectric constant and the lower and upper electrodes 112 and 116 are formed using metals having a relatively high work function, the first capacitor may have good leakage current characteristics because of the large difference of the work function therebetween. Additionally, when the upper electrode 116 is formed using the noble metal having a relatively strong acid-resistance, a metal oxide layer may generally not be formed on the upper electrode 116, so that the relatively high capacitance of the first capacitor may be preserved.

Referring to FIG. 8, a capping layer 118 may be formed on the upper electrode 116. The capping layer 118 may reduce, inhibit, and/or prevent growth and/or conglomeration of grains of the upper electrode 116.

The capping layer 118 may be formed at a temperature of about 10° C. to about 300° C. so that grain growth in the upper electrode 116 may be prevented and/or minimized during the formation of the capping layer 118. In other words, the capping layer 118 may be formed at a temperature that is insufficient to induce grain growth in the upper electrode 116.

The capping layer 118 may be formed using a material having good step coverage characteristics and not being transformed by stress.

The capping layer 118 may be formed using an oxide. For example, the capping layer 118 may be formed using zirconium oxide (ZrO₂), hafnium dioxide (HfO₂), aluminum oxide (Al₂O₃), lanthanum monoaluminate (LaAlO₃), barium zirconate (BaZrO₃), strontium zirconate (SrZrO₃), BST, strontium titanate (SrTiO₃), barium titanate (BaTiO₃), titanium dioxide (TiO₂), silicon oxide (SiO₂), etc. These may be used alone or in combination thereof. In some embodiments, the capping layer 118 may be formed using zirconium oxide (ZrO₂) or hafnium dioxide (HfO₂) having tensile stress on the silicon substrate 100.

In example embodiments, the capping layer 118 may be formed by an ALD process, a CVD process or a PVD process. In example embodiments, the capping layer 118 may be formed by a spin coating process. The capping layer 118 may be formed in some embodiments by an ALD process having good step coverage characteristics.

The capping layer 118 may be formed to have a thickness of about 5 Å to about 3000 Å.

When a plurality of lower electrodes 112 are formed, the capping layer 118 may be formed to fill spaces between the lower electrodes 112.

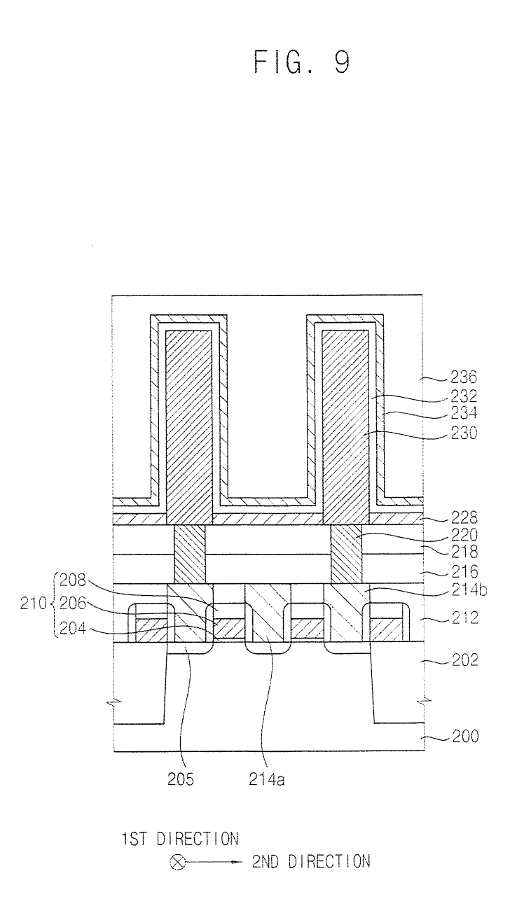

FIG. 9 is a cross-sectional view illustrating a first semiconductor device having the first capacitor of FIG. 1 in accordance with example embodiments.

Referring to FIG. 9, a substrate 200 having an active region and an isolation region may be provided. The active region and the isolation region may be defined by the isolation layer 202 on the substrate 200.

Metal-oxide-semiconductor (MOS) transistors may be formed on the substrate 200. Each MOS transistor may include a gate structure 210 and a source/drain region 205 adjacent to the gate structure 210 at an upper portion of the substrate 200. The gate structure 210 may include a gate insulation layer 204, a gate electrode 206 and a hard mask 208 sequentially stacked on the substrate 200. The gate structure 210 may extend in a first direction. The gate structure 210 may function as a word line in some embodiments.

A first insulating interlayer 212 may be formed on the substrate 200 to cover the gate structures 210. A first contact pad 214a and a second contact pad 214b may be formed to extend through the first insulating interlayer 212. The first and second contact pads 214a and 214b may be electrically connected to respective source/drain regions 205.

A second insulating interlayer 216 may be formed on the first insulating interlayer 212 and the contact pads 214a and 214b. A bit line contact pad (not shown) electrically connected to the first contact pad 214a may be formed to extend through the second insulating interlayer 216. Additionally, a bit line (not shown) electrically connected to the bit line contact pad may be formed on the second insulating interlayer 216. The bit line may extend in a second direction perpendicular to the first direction.

A third insulating interlayer 218 may be formed on the second insulating interlayer 216 to cover the bit line. A contact plug 220 electrically connected to the second contact pad 214b may be formed to extend through the second and third insulating interlayers 216 and 218.

The first capacitor may be formed on the third insulating interlayer 218. Particularly, a lower electrode 230, which is electrically connected to the contact plug 220, a dielectric layer 232, an upper electrode 234, and a capping layer 236 may be formed on the third insulating interlayer 218. Additionally, an etch stop layer 228 may extend between the third insulating interlayer 218 and the dielectric layer 232.

The first semiconductor device having the first capacitor of FIG. 1 may provide a relatively high degree of integration and good electrical characteristics because the first capacitor may have a relatively high capacitance.

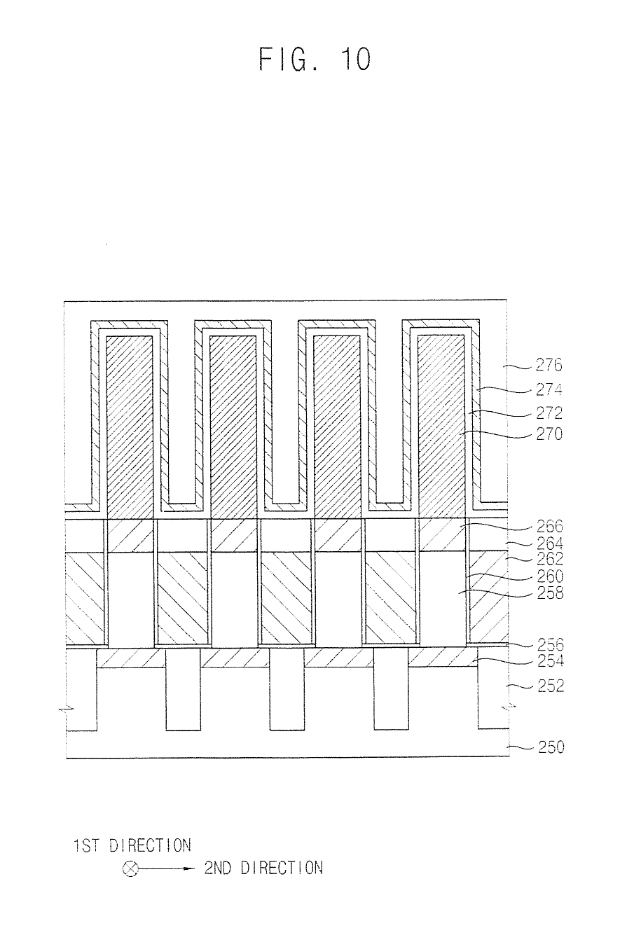

FIG. 10 is a cross-sectional view illustrating a second semiconductor device having the first capacitor in FIG. 1 in accordance with example embodiments.

Referring to FIG. 10, a substrate 250 having an active region and an isolation region may be provided. The active region and the isolation region may be defined by a plurality of isolation layers 252 on the substrate 250. Each active region and each isolation region may extend in a first direction.

A bit line 254 may be formed at an upper portion of each active region. The bit line 254 may extend in the first direction. The bit line 254 may be doped with impurities.

A pillar 258 may be formed on each active region of the substrate 250. The pillar 258 may protrude from the substrate 250. The pillar 258 may include single crystalline silicon.

An insulation layer pattern 256 may be formed on the substrate 250. The insulation layer pattern 256 may electrically insulate a gate electrode 262 from the substrate 250.

A gate insulation layer 260 may be formed on a surface of each pillar 258 except for bottom and top surfaces thereof. The gate electrode 262 may be formed on the gate insulation layer 260 and on the insulation layer pattern 256. The gate electrode 262 may extend in a second direction perpendicular to the first direction and surround lower portions of the pillars 258. The gate electrode 262 may serve as a word line.

An insulating interlayer 264 may be formed on the substrate 250 and the gate electrode 262. The insulating interlayer 264 may fill spaces between the gate electrodes 262 and spaces between the pillars 258. A top surface of the insulating interlayer 264 may have a height substantially the same as that of the pillars 258.

An impurity region 266 may be formed at an upper portion of each pillar 258. The impurity region 266 may serve as a source/drain region.

As illustrated above, a plurality of vertical channel transistors may be formed on the substrate 250, where each vertical transistor includes the gate electrode 262, the vertical channel 258, and the source/drain regions 266.

A plurality of capacitors each of which is substantially the first capacitor of FIG. 1 and electrically connected to the impurity region 266 may be formed on the insulating interlayer 264. Particularly, a lower electrode 270, a dielectric layer 272, an upper electrode 274 and a capping layer 276 may be formed on the insulating interlayer 264.

FIG. 11 is a cross-sectional view illustrating a second capacitor according to example embodiments.

Referring to FIG. 11, an insulating interlayer 152 may be formed on the substrate 150. A contact plug 154 contacting the substrate 150 may be formed through the insulating interlayer 152. In example embodiments, a plurality of contact plugs 154 may be formed to extend through the insulating interlayer 152. Other devices such as transistors (not shown) and wirings (not shown) may be further formed on the substrate 150.

An etch stop layer 156 may be formed on the insulating interlayer 152. The etch stop layer 156 may include silicon nitride.

A mold layer 158 may be formed on the etch stop layer 156. The mold layer 158 and the etch stop layer 156 may have openings (not shown) exposing the contact plugs 154. The mold layer 158 may include silicon oxide.

A lower electrode 162a may be formed on a bottom and a sidewall of each opening. Thus, the lower electrode 162a may be electrically connected to the contact plug 154. The lower electrode 162a may have a cylindrical shape. The lower electrode 162a may include a material substantially the same as that of the lower electrode 112 in FIG. 1.

A dielectric layer 164 may be formed on the lower electrode 162a and the mold layer 158. The dielectric layer 164 may include a material substantially the same as that of the dielectric layer 114 in FIG. 1.

An upper electrode 166 may be formed on the dielectric layer 164. The upper electrode 166 may include a material substantially the same as that of the upper electrode 116 in FIG. 1.

A capping layer 168 may be formed on the upper electrode 166. The capping layer 168 may fill the remaining portions of the openings. The capping layer 168 may include a material substantially the same as that of the capping layer 118 in FIG. 1.

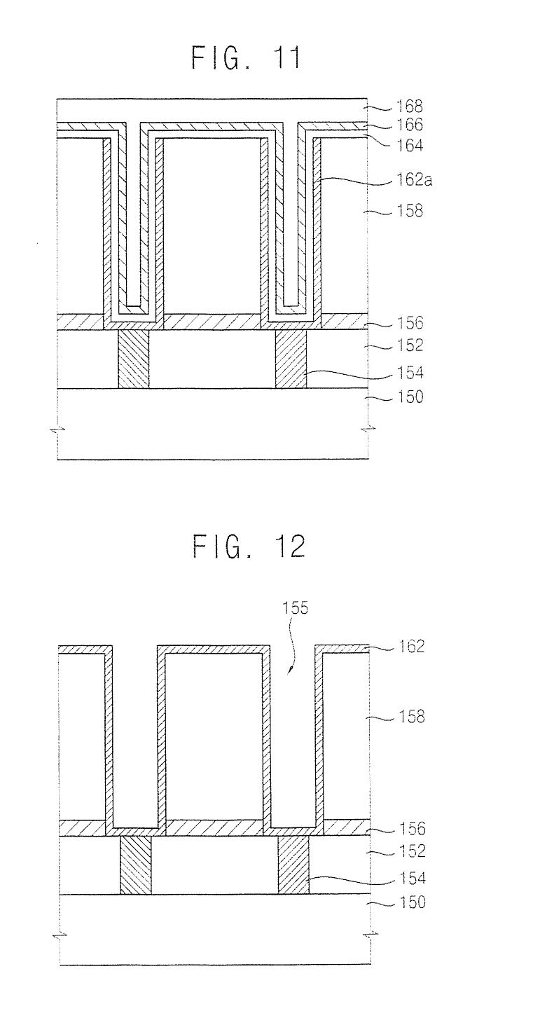

FIGS. 12 to 14 are cross-sectional views illustrating a method of forming the second capacitor in accordance with example embodiments. The method of forming the second capacitor may be substantially similar to the method of forming the first capacitor of FIG. 1 except for the formation of the lower electrode 162.

Referring to FIG. 12, an insulating interlayer 152 having the contact plugs 154 extending therethrough may be formed on a substrate 150. An etch stop layer 156 and a mold layer 158 may be formed on the insulating interlayer 152. Openings 155 may be formed through the mold layer 158 and the etch stop layer 156 to expose the contact plugs 154.

A first conductive layer 162 may be formed on the bottom surfaces and on sidewalls of the openings 155 in the mold layer 158. Thus, the first conductive layer 162 may be formed to contact the contact plugs 154. The first conductive layer 162 may not fill the openings 155.

The first conductive layer 162 may be formed using a material substantially the same as that of the lower electrode 112 in FIG. 1.

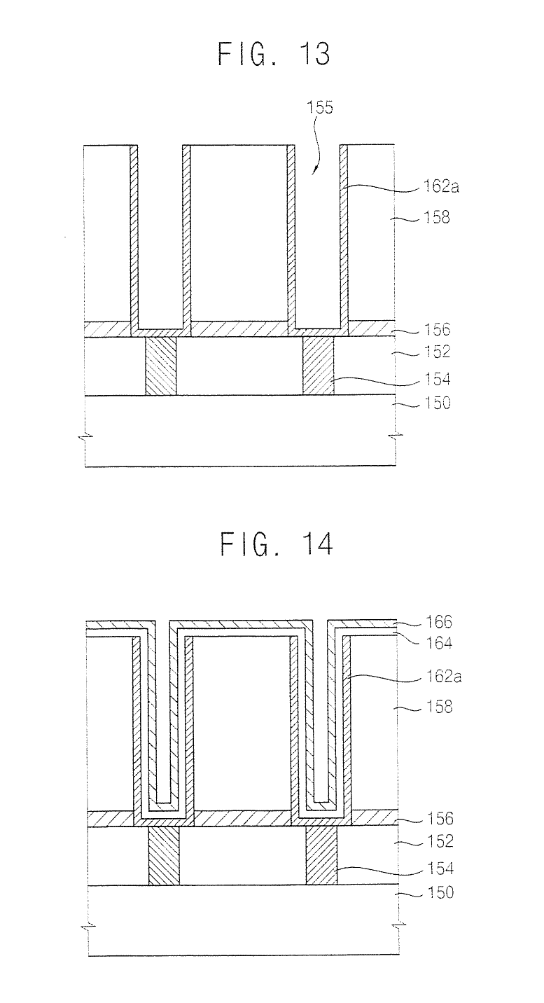

Referring to FIG. 13, a portion of the first conductive layer 162 on the upper surface of the mold layer 158 may be removed to form a lower electrode 162a on the bottom surfaces and the sidewalls of the openings 155. The portion of the first conductive layer 162 on the mold layer 158 may be removed by a photolithography process.

Referring to FIG. 14, a dielectric layer 164 may be formed on the lower electrode 162a and the mold layer 158. The dielectric layer 164 may be formed using a material substantially the same as that of the dielectric layer 114 in FIG. 1 by a process substantially similar to that of FIG. 6.

An upper electrode 166 may be formed on the dielectric layer 164. The upper electrode 166 may be formed using a material substantially similar to that of the upper electrode 116 in FIG. 1 by a process substantially the same as that of FIG. 7.

A capping layer 168 (as shown in FIG. 11) may be formed on the upper electrode 166 to fill the remaining portions of the openings. The capping layer 168 may be formed using a material substantially the same as that of the capping layer 118 in FIG. 1 by a process substantially similar to that of FIG. 8.

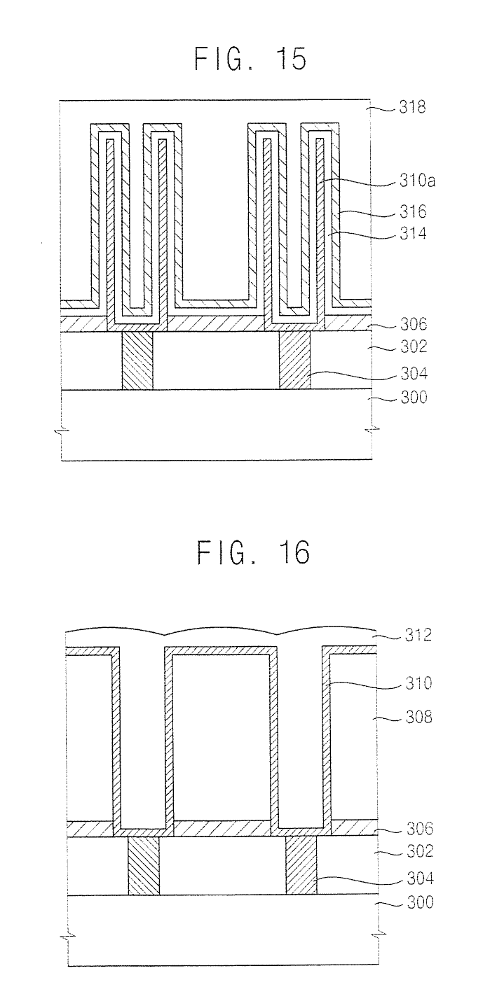

FIG. 15 is a cross-sectional view illustrating a third capacitor according to example embodiments.

Referring to FIG. 15, an insulating interlayer 302 may be formed on the substrate 300. A contact plug 304 contacting the substrate 300 may be formed to extend through the insulating interlayer 302. In example embodiments, a plurality of contact plugs 304 may be formed extending through the insulating interlayer 302. Other device such as transistors (not shown) and wirings (not shown) may be further formed on the substrate 300.

An etch stop layer 306 may be formed on the insulating interlayer 302. The etch stop layer 306 may include silicon nitride.

A lower electrode 310a electrically connected to the contact plug 304 may be formed on the insulating interlayer 302. The lower electrode 310a may have a cylindrical shape. The lower electrode 310a may include a material substantially the same as that of the lower electrode 112 in FIG. 1.

A dielectric layer 314 may be formed on the lower electrode 310a and the etch stop layer 306. The dielectric layer 314 may include a material substantially the same as that of the dielectric layer 114 in FIG. 1.

An upper electrode 316 may be formed on the dielectric layer 314. The upper electrode 316 may include a material substantially the same as that of the upper electrode 116 in FIG. 1.

A capping layer 318 may be formed on the upper electrode 316. The capping layer 318 may fill spaces between the lower electrodes 310a and inner spaces formed by the lower electrodes 310a. The capping layer 318 may include a material substantially the same as that of the capping layer 118 in FIG. 1.

FIGS. 16 to 18 are cross-sectional views illustrating a method of forming the third capacitor in accordance with example embodiments. The method of forming the third capacitor may be substantially similar to that of the first capacitor except for the formation of the lower electrode 310a.

Referring to FIG. 16, an insulating interlayer 302 having the contact plugs 304 therethrough may be formed on a substrate 300. An etch stop layer 306 and a mold layer 308 may be formed on the insulating interlayer 302. Openings (not shown) may be formed extending through the mold layer 308 and the etch stop layer 306 to expose the contact plugs 304.

A first conductive layer 310 may be formed on bottom surfaces and sidewalls of the openings in the mold layer 308. Thus, the first conductive layer 310 may be formed to contact the contact plugs 304. The first conductive layer 310 may not fill the openings. The first conductive layer 310 may be formed using a material substantially the same as that of the lower electrode 112 in FIG. 1.

A sacrificial layer 312 may be formed on the first conductive layer 310 to fill the remaining portions of the openings. The sacrificial layer 312 may be formed using a material substantially the same as that of the mold layer 308. In example embodiments, the sacrificial layer 312 may be formed using silicon oxide.

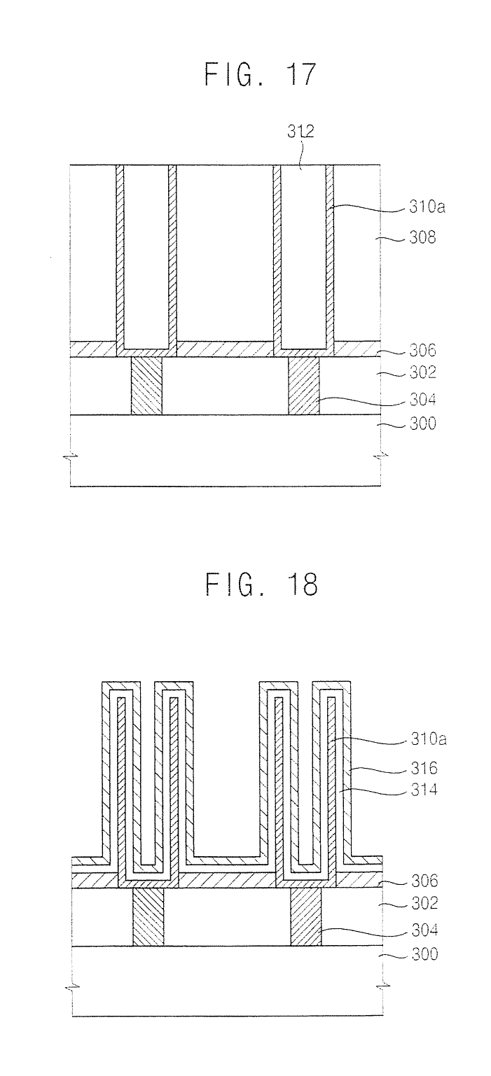

Referring to FIG. 17, an upper portion of the first conductive layer 310 may be planarized until a top surface of the mold layer 308 is exposed, thereby forming a lower electrode 310a having a cylindrical shape. The planarization may be performed by a chemical mechanical polishing (CMP) process and/or an etch back process.

Referring to FIG. 18, the sacrificial layer 312 and the mold layer 308 may be removed, thereby exposing the lower electrode 310a. In example embodiments, the removal may be performed by a wet etching process.

A dielectric layer 314 may be formed on the lower electrode 310a and the etch stop layer 306. The dielectric layer 314 may be formed using a material substantially the same as that of the dielectric layer 114 in FIG. 1 by a process substantially similar to that of FIG. 6.

An upper electrode 316 may be formed on the dielectric layer 314. The upper electrode 316 may be formed using a material substantially the same as that of the upper electrode 116 in FIG. 1 by a process substantially similar to that of FIG. 7.

A capping layer (not shown) may be formed on the upper electrode 316. The capping layer may be formed using a material substantially the same as that of the capping layer 118 in FIG. 1 by a process substantially similar to that of FIG. 8.

FIG. 19 is a graph illustrating leakage current characteristics of a capacitor when the capacitor is heated. Reference numeral 10 shows a leakage current of a capacitor having a lower electrode of ruthenium, a dielectric layer of BST, and an upper electrode of ruthenium. The lower electrode has a pillar shape. Reference numeral 12 shows a leakage current of the capacitor after the capacitor was heated at a temperature of about 400° C.

Referring to FIG. 19, the leakage current of the capacitor without being heated is lower than that of the capacitor being heated at the temperature of about 400° C.

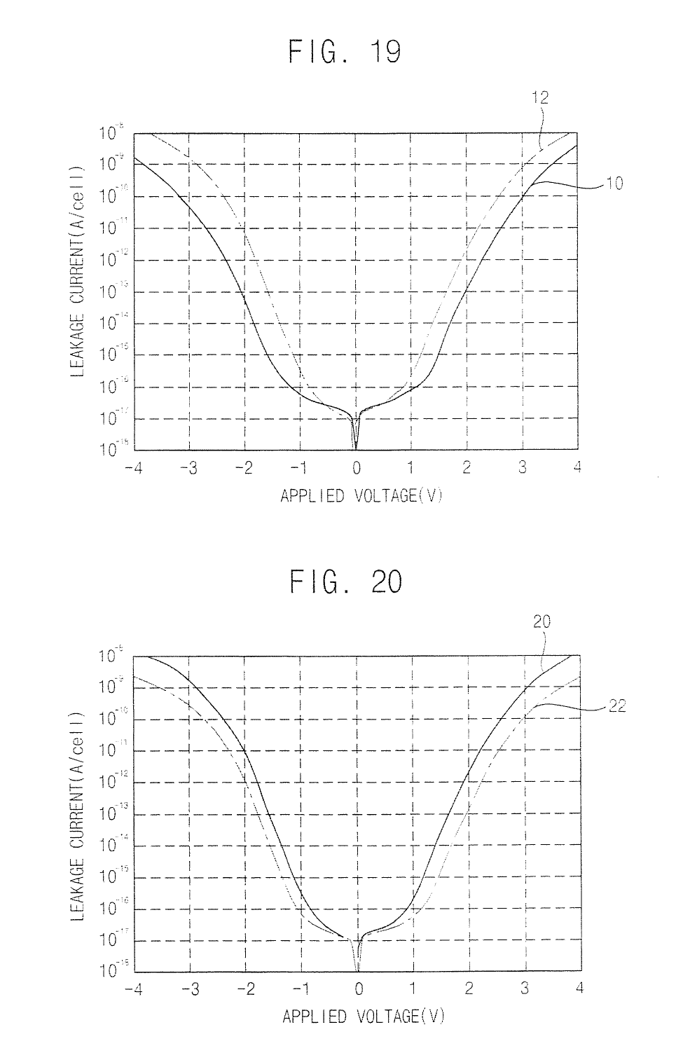

FIG. 20 is a graph illustrating leakage current characteristics of a capacitor when the capacitor has a capping layer. Reference numeral 20 shows a leakage current of a Comparative Example, i.e., a capacitor having a lower electrode of ruthenium, a dielectric layer of BST, and an upper electrode of ruthenium. The lower electrode has a pillar shape.

Reference numeral 22 shows a leakage current of a capacitor in accordance with Example embodiments of the present inventive concept, i.e., a capacitor having the lower electrode of ruthenium, the dielectric layer of BST, the upper electrode of ruthenium, and a capping layer of zirconium oxide (ZrO₂). Both capacitors were heated at a temperature of about 400° C.

Referring to FIG. 20, the leakage current of the capacitor in accordance with Example embodiments of the inventive concept is lower than that of the capacitor of the Comparative Example.

According to some example embodiments, a capacitor according to embodiments of the inventive concept may include a dielectric layer of a high-k material, and a capping layer that reduces, prevents, and/or inhibits grain growth in an upper electrode on which it is formed. Thus, the capacitor may have a reduced leakage current.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims.

Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

1. A method of fabricating a capacitor, the method comprising:
forming a lower electrode;
forming a dielectric layer on the lower electrode;
forming a upper electrode on the dielectric layer opposite the lower electrode; and
forming a low-temperature capping layer on the upper electrode at a temperature that is insufficient to induce grain growth in the upper electrode.

2. The method of claim 1, wherein the low-temperature capping layer comprises an oxide layer formed at a temperature of about 10 degrees Celsius (° C.) to about 300° C.

3. The method of claim 2, wherein the low-temperature capping layer is configured to substantially inhibit grain growth in the upper electrode during subsequent thermal processes.

4. The method of claim 1, wherein the upper electrode comprises a material having a higher work function than the dielectric layer.

5. The method of claim 4, wherein the dielectric layer comprises a metal oxide having a higher dielectric constant than silicon dioxide (SiO₂).

6. The method of claim 5, wherein the dielectric layer comprises a perovskite material.

7. The method of claim 6, wherein the dielectric layer comprises at least one of (Ba, Sr)TiO₃ (BST), strontium titanate (SrTiO₃), barium titanate (BaTiO₃), PZT, PLZT, (Ba, Sr)(Zr, Ti)O₃ (BSZTO), Sr(Zr, Ti)O₃ (SZTO), Ba(Zr, Ti)O₃ (BZTO), (Ba, Sr)ZrO₃ (BSZO), strontium zirconate (SrZrO₃), and barium zirconate (BaZrO₃).

8. The method of claim 5, wherein the dielectric layer comprises at least one of zirconium oxide (ZrO₂), hafnium dioxide (HfO₂), aluminum oxide (Al₂O₃), tantalum oxide (Ta₂O₅), and titanium oxide (TiO₂).

9. The method of claim 4, wherein the upper electrode comprises a noble metal.

10. The method of claim 9, wherein the upper electrode comprises at least one of platinum (Pt), ruthenium (Ru), and iridium (Ir).

11. The method of claim 4, wherein the upper electrode comprises a conductive noble metal oxide and/or a conductive perovskite oxide.

12. The method of claim 11, wherein the upper electrode comprises at least one of platinum monoxide (PtO), ruthenium dioxide (RuO₂), iridium dioxide (IrO₂), strontium ruthenate (SrRuO₃), barium ruthenate (BaRuO₃), calcium ruthenate (CaRuO₃), and (Ba, Sr)RuO₃.

13. The method of claim 2, wherein forming the low-temperature capping layer comprises forming the low-temperature capping layer using an atomic layer deposition (ALD) process or a spin coating process.

14. The method of claim 2, wherein the low-temperature capping layer comprises at least one selected from the group consisting of zirconium oxide (ZrO₂), hafnium dioxide (HfO₂), aluminum oxide (Al₂O₃), lanthanum monoaluminate (LaAlO₃), barium zirconate (BaZrO₃), strontium zirconate (SrZrO₃), BST, strontium titanate (SrTiO₃), barium titanate (BaTiO₃), titanium dioxide (TiO₂) and silicon oxide (SiO₂).

15. The method of claim 1, wherein the low-temperature capping layer comprises an oxide layer under tensile stress.

16. The method of claim 15, wherein the low-temperature capping layer has a thickness of about 5 Angstroms (Å) to about 3000 Å.

17. The method of claim 1, wherein forming the lower electrodes comprises forming a plurality of lower electrodes on a substrate, and wherein forming the capping layer comprises forming the capping layer on the upper electrode to substantially fill spaces between the plurality of lower electrodes.

18-23. (canceled)
